(19) United States
(12) Patent Application Publication
(10) Pub. No.: US 2018/0343023 A1
(43) Pub. Date: Nov. 29, 2018

(54) WATCH TYPE MOBILE TERMINAL AND OPERATING METHOD THEREFOR

(71) Applicant: LG ELECTRONICS INC., Seoul (KR)

(72) Inventors: Jisoo PARK, Seoul (KR); Hongjo SHIM, Seoul (KR); Youngho SOHN, Seoul (KR)

(73) Assignee: LG ELECTRONICS INC., Seoul (KR)

(21) Appl. No.: 15/755,990

(22) PCT Filed: Oct. 6, 2015
(86) PCT No.: PCT/KR2015/010567

§ 371 Date: Aug. 2, 2018

(30) Foreign Application Priority Data
Aug. 28, 2015 (KR) 10-2015-0122160

(51) Int. Cl. H04B 1/3805; H04W 76/14

(52) U.S. Cl. CPC H04B 1/3805; H04W 76/14

(57) ABSTRACT

A watch type mobile terminal comprises: a touch screen; a bezel encompassing the border of the touch screen; a display unit in which a first operation for performing dragging to the bezel on the touch screen is inputted; a sensing unit for recognizing a second operation of a user who moves a finger while being spaced at a predetermined distance from the watch type mobile terminal; and a control unit for switching to a gesture mode in which the watch type mobile terminal is controlled by the second operation when the first operation is inputted.

### TECHNICAL FIELD

The present invention relates to a watch type mobile terminal used in consideration of user convenience.

### BACKGROUND ART

Terminals may be generally classified as mobile/portable terminals or stationary terminals according to their mobility. Mobile terminals may also be classified as handheld terminals or vehicle mounted terminals according to whether or not a user may directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

Users mostly hold and use the mobile terminals by their hands and furthermore, the mobile terminals may be expanded to wearable devices which may be worn on their bodies. The wearable devices include a watch-type mobile terminal, a glass-type mobile terminal, a head mounted display (HMD), and so on.

Among others, the watch-type mobile terminal is formed by the adding of electronic, communication and multimedia functions to a watch which a human being always wear, and it seems that a big market is formed in the future because the watch-type mobile terminal does not provide antipathy to the human being.

Thus, research, development and commercialization of the watch-type mobile terminal are being actively conducted.

### DISCLOSURE

### Technical Problem

An object of the present invention is to provide a watch type mobile terminal capable of performing user input without restriction of a touch region by moving a finger outside the touch region.

### Technical Solution

The object of the present invention can be achieved by providing a watch type mobile terminal including a display unit including a touchscreen and a bezel surrounding a border of the touchscreen to receive first operation for dragging to the bezel on the touchscreen, a sensing unit for recognizing second operation for moving a finger of a user at a predetermined distance from the watch type mobile terminal, and a control unit for switching to a gesture mode in which the watch type mobile terminal is controlled by the second operation when the first operation is received.

In another aspect of the present invention, provided herein is a method of operating a watch type mobile terminal including receiving first operation for dragging to a bezel on a touchscreen and switching to a gesture mode in which the watch type mobile terminal is controlled by second operation for moving a finger of a user at a predetermined distance from the watch type mobile terminal, when the first operation is recognized.

### Advantageous Effects

According to embodiments of the present invention, it is possible to perform user input without restriction of a touch region by moving a finger outside the touch region.

### DESCRIPTION OF DRAWINGS

FIG. 1 is a block diagram illustrating a mobile terminal related to the present invention.

FIG. 2 is a perspective view illustrating one example of a watch-type mobile terminal related to the present invention.

FIGS. 3a and 3b are diagrams illustrating touch input in a general watch type mobile terminal.

FIG. 4 is a flowchart illustrating a method of operating a watch type mobile terminal according to an embodiment of the present invention.

FIGS. 5a to 5c are diagrams illustrating switching of three input modes of a watch type mobile terminal according to an embodiment of the present invention.

FIG. 6 is a diagram illustrating a process of recognizing a gesture according to an embodiment of the present invention.

FIGS. 7a and 7b are diagrams showing the configuration of an antenna mounted in a watch type mobile terminal according to an embodiment of the present invention.

FIG. 8 is a diagram illustrating recognition of motion of a user using an RF signal according to an embodiment of the present invention.

FIGS. 9a to 9g are diagrams showing a gesture according to an embodiment of the present invention.

FIG. 10 is a diagram showing input of a gesture according to an embodiment of the present invention.

FIGS. 11a and 11b are diagrams illustrating control of a watch type mobile terminal by a gesture according to an embodiment of the present invention.

FIGS. 12a to 12c are diagrams illustrating control of a watch type mobile terminal by a gesture according to an embodiment of the present invention.

FIGS. 13a to 13d are diagrams illustrating a process of controlling a map application by a gesture according to an embodiment of the present invention.

FIGS. 14a to 14c are diagrams illustrating a process of controlling a gallery application by a gesture according to an embodiment of the present invention.

FIGS. 15a and 15b are diagrams illustrating a process of controlling a music application by a gesture according to an embodiment of the present invention.

FIGS. 16a and 16b are diagrams illustrating a process of controlling an address book application by a gesture according to an embodiment of the present invention.

### BEST MODE

Hereinafter, embodiments are described in more detail with reference to accompanying drawings and regardless of the drawings symbols, same or similar components are assigned with the same reference numerals and thus repetitive for those are omitted. Since the suffixes “module” and “unit” for components used in the following description are given and interchanged for easiness in making the present disclosure, they do not have distinct meanings or functions. In the following description, detailed descriptions of well-known functions or constructions will be omitted because they would obscure the present invention in unnecessary detail. Also, the accompanying drawings are used to help easily understanding embodiments disclosed herein but the technical idea of the present invention is not limited thereto. It should be understood that all of variations, equivalents or substitutes contained in the concept and technical scope of the present invention are also included.

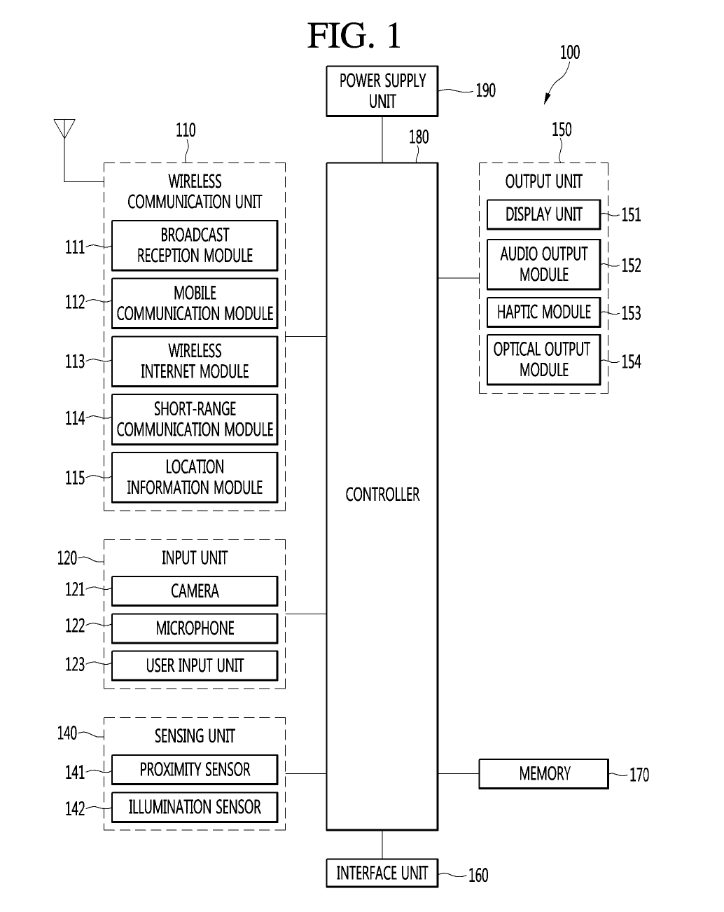

FIG. 1 is a block diagram for explaining a mobile terminal related to an embodiment.

A watch-type mobile terminal 100 may include a wireless communication unit 110, an input unit 120, a sensing unit 140, an output unit 150, an interface unit 160, a memory 170, a control unit 180, and a power supply unit 190. In implementing the watch-type mobile terminal, components shown in FIG. 1 are not necessary, so the watch-type mobile terminal described in this specification may include more or less components than those listed above.

In more detail, the wireless communication unit 110 typically includes one or more modules which permit communications such as wireless communications between the watch-type mobile terminal 100 and a wireless communication system, communications between the watch-type mobile terminal 100 and another mobile terminal, communications between the watch-type mobile terminal 100 and an external server. Further, the wireless communication unit 110 typically includes one or more modules which connect the watch-type mobile terminal 100 to one or more networks.

The wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by control unit 180 according to device parameters, user commands, and combinations thereof.

The sensing unit 140 may include one or more sensors to sense at least one of internal information of the watch-type mobile terminal, surrounding environment information of the watch-type mobile terminal, and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like). The watch-type mobile terminal 100 may be configured to utilize the combination of information sensed of at least two of the sensors.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the watch-type mobile terminal 100 and a user, as well as function as the user input unit 123 which provides an input interface between the watch-type mobile terminal 100 and the user.

The interface unit 160 serves as an interface with various types of external devices that may be coupled to the watch-type mobile terminal 100. The interface unit 160, for example, may include any of wired or wireless ports, external charging ports, wired or wireless data ports, memory card ports, ports for connecting a device having an identification module, audio input/output (I/O) ports, video I/O ports, earphone ports, and the like. In some cases, the watch-type mobile terminal 100 may perform assorted control functions associated with a connected external device, in response to the external device being connected to the interface unit 160.

The memory 170 is typically implemented to store data to support various functions or features of the watch-type mobile terminal 100. For instance, the memory 170 may be configured to store application programs executed in the watch-type mobile terminal 100, data or instructions for operations of the watch-type mobile terminal 100, and the like. Some of these application programs may be downloaded from an external server via wireless communication. Other application programs may be installed within the watch-type mobile terminal 100 at time of manufacturing or shipping, which is typically the case for basic functions of the watch-type mobile terminal 100 (for example, receiving a call, placing a call, receiving a message, sending a message, and the like). It is common for application programs to be stored in the memory 170, installed in the watch-type mobile terminal 100, and executed by the control unit 180 to perform an operation (or function) for the watch-type mobile terminal 100.

The control unit 180 typically functions to control overall operation of the watch-type mobile terminal 100, in addition to the operations associated with the application programs. The control unit 180 may provide or process information or functions appropriate for a user by processing signals, data, information and the like, which are input or output by the various components as described above, or activating application programs stored in the memory 170.

The control unit 180 may provide or process information or functions appropriate for a user by processing signals, data, information and the like, which are input or output by the various components depicted in FIG. 1, or activating application programs stored in the memory 170. Further, the control unit 180 operates at least two of components included in the watch-type mobile terminal 100 by combining the at least two of components.

The power supply unit 190 may be configured to receive external power or provide internal power in order to supply appropriate power required for operating elements and components included in the watch-type mobile terminal 100, under the control of the control unit 180. The power supply unit 190 may include a battery, and the battery may be configured to be embedded in the terminal body, or configured to be detachable from the terminal body.

At least some of the components may operate in cooperation with each other to realize the operation, the control, or the control method of a watch-type mobile terminal according to various embodiments to be described below. In addition, the operation, the control, or the control method of a watch-type mobile terminal may be realized on the watch-type mobile terminal by running at least one application program stored in the memory 170.

Before the description of various embodiments realized through the watch-type mobile terminal 100 described above, the above components will be described in more detail with reference to FIG. 1.

Regarding the wireless communication unit 110, the broadcast receiving module 111 of the wireless communication unit is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules may be provided in the watch-type mobile terminal 100 for simultaneously receiving of two or more broadcast channels, or to support switching among broadcast channels.

The mobile communication module 112 may transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

Examples of wireless signals include voice call signals, video (telephony) call signals, or various formats of data to support communication of text and multimedia messages.

The wireless Internet module 113, which refers to a module to access the wireless Internet, may be embedded in the mobile terminal 100 or provided outside the mobile terminal 100. The wireless Internet module 113 may transmit and/or receive wireless signals via communication networks according to wireless Internet technologies

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

When the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include Bluetooth™, Radio Frequency Identification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the watch-type mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

The short-range communication module 114 may sense or recognize the wearable device, and permit communication between the wearable device and the watch-type mobile terminal 100. In addition, when the sensed wearable device is a device which is authenticated to communicate with the watch-type mobile terminal 100, the control unit 180, for example, may cause transmission of data processed in the watch-type mobile terminal 100 to the wearable device via the short-range communication module 114. Hence, a user of the wearable device may use the data processed in the watch-type mobile terminal 100 on the wearable device. For example, when a call is received in the watch-type mobile terminal 100, the user may answer the call using the wearable device. Also, when a message is received in the watch-type mobile terminal 100, the user may check the received message using the wearable device.

The location information module 115 is a module to acquire a location of the mobile terminal. As an example, the location information module 115 representatively includes a Global Position System (GPS) module, a Wi-Fi module, or both. For example, if the mobile terminal utilizes the GPS module, the position of the mobile terminal may be acquired by using the signal sent from the GPS satellite. Alternatively, if the mobile terminal utilizes the Wi-Fi module, the position of the mobile terminal may be acquired based on the information of a wireless access point (AP) for transmitting or receiving a wireless signal together with the Wi-Fi module. If necessary, the location information module 115 may any one of functions of other modules of the wireless communication unit 110 to alternatively or additionally acquire the location data of the mobile terminal. The location information module 115, which is a module used to acquire the location (or current location) of the mobile terminal, is not limited to a module to directly calculate or acquire the position of the mobile terminal.

The input unit 120 may be configured to permit various types of input to the mobile terminal 120. Examples of such input include audio, image, video, data, and user input. In order to obtain the input of video information, the watch-type mobile terminal 100 may include one or more cameras 121. Such cameras 121 may process image frames of still pictures or video obtained by image sensors in a video or image capture mode. The processed image frames may be displayed on the display unit 151 or stored in memory 170. In some cases, the cameras 121 may be arranged in a matrix configuration to permit a plurality of images having various angles or focal points to be input to the watch-type mobile terminal 100. As another example, the cameras 121 may be located in a stereoscopic arrangement to acquire left and right images for implementing a stereoscopic image.

The microphone 122 converts external sound signal into electrical voice signal. The processed voice data may be utilized variously depending on functions (or application under running) executed by the watch-type mobile terminal 100. If desired, the microphone 122 may include assorted noise removing algorithms to remove unwanted noise generated in the course of receiving the external sound.

The user input unit 123 is a component that permits input by a user. Such user input may enable the control unit 180 to control operation of the watch-type mobile terminal 100. The user input unit 123 may include one or more of a mechanical input element (for example, a key, a button located on a front and/or rear surface or a side surface of the watch-type mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The control unit 180 generally cooperates with the sending unit 140 to control operation of the watch-type mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 may sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, the control unit 180 processes data (or information) corresponding to proximity touches and proximity touch patterns sensed by the proximity sensor 141, and cause output of visual information on the touch screen. In addition, the control unit 180 may control the watch-type mobile terminal 100 to execute different operations or process different data according to whether a touch with respect to a point on the touch screen is either a proximity touch or a contact touch.

A touch sensor may sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, a corresponding signal (signals) may be transmitted to a touch controller. The touch controller may process the received signal (signals), and then transmit corresponding data to the control unit 180. Accordingly, the control unit 180 may sense which region of the display unit 151 has been touched. Here, the touch controller may be a component separate from the control unit 180, the control unit 180, and combinations thereof.

Meanwhile, the control unit 180 may execute the same or different controls according to a type of touch object that touches the touch screen or a touch key provided in addition to the touch screen. Whether to execute the same or different control according to the object which provides a touch input may be decided based on a current operating state of the watch-type mobile terminal 100 or a currently executed application program, for example.

Meanwhile, the touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

An ultrasonic sensor may be implemented to recognize position information relating to a touch object using ultrasonic waves. The control unit 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121, which is described as an element of the input unit 12, typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the watch-type mobile terminal 100. For example, the display unit 151 may display execution screen information of an application program executing at the watch-type mobile terminal 100 or user interface (UI) and graphic user interface (GUI) information in response to the execution screen information.

The audio output module 152 is generally configured to output audio data received from the wireless communication unit 110 or stored in the memory 170 during modes such as a signal reception mode, a call mode, a record mode, a voice recognition mode, a broadcast reception mode, and the like. The audio output module 152 may provide audible output related to a particular function (e.g., a call signal reception sound, a message reception sound, etc.) performed by the watch-type mobile terminal 100. The audio output module 152 may also be implemented as a receiver, a speaker, a buzzer, or the like.

A haptic module 153 may be configured to generate various tactile effects that a user feels, perceive, or otherwise experience. A typical example of a tactile effect generated by the haptic module 153 is vibration. The strength, pattern and the like of the vibration generated by the haptic module 153 may be controlled by user selection or setting by the controller. For example, the haptic module 153 may output different vibrations in a combining manner or a sequential manner.

The haptic module 153 may generate, in addition to the vibration, various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that may absorb or generate heat, and the like.

The haptic module 153 may also be implemented to allow the user to feel a tactile effect through a muscle sensation such as the user's fingers or arm, as well as transferring the tactile effect through direct contact. Two or more haptic modules 153 may be provided according to the particular configuration of the watch-type mobile terminal 100.

An optical output module 154 may output a signal for indicating an event generation using light of a light source. Examples of events generated in the watch-type mobile terminal 100 may include message reception, call signal reception, a missed call, an alarm, a schedule notice, an email reception, information reception through an application, and the like.

A signal output by the optical output module 154 may be implemented in such a manner that the watch-type mobile terminal emits monochromatic light or light with a plurality of colors to the front surface or rear surface thereof. The signal output may be terminated as the watch-type mobile terminal senses that a user has checked the generated event.

The interface unit 160 serves as an interface for external devices to be connected with the mobile terminal 100. For example, the interface unit 160 may receive data transmitted from an external device, receive power to transfer to elements and components within the watch-type mobile terminal 100, or transmit internal data of the watch-type mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various pieces of information for authenticating authority of using the watch-type mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device may be connected with the terminal 100 via the interface unit 160.

When the watch-type mobile terminal 100 is connected with an external cradle, the interface unit 160 may serve as a passage to allow power from the cradle to be supplied to the watch-type mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 may store programs to support operations of the control unit 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The watch-type mobile terminal 100 may also be operated in relation to a network storage device that performs the storage function of the memory 170 over a network, such as the Internet.

Meanwhile, as described above, the control unit 180 may typically control the general operations of the watch-type mobile terminal 100. For example, the control unit 180 may set or release a lock state for restricting a user from inputting a control command with respect to applications when a status of the mobile terminal meets a preset condition.

The control unit 180 may also perform the controlling and processing associated with voice calls, data communications, video calls, and the like, or perform pattern recognition processing to recognize a handwriting input or a picture drawing input performed on the touch screen as characters or images, respectively. In addition, the control unit 180 may control one or a combination of those components in order to implement various exemplary embodiments disclosed herein.

The power supply unit 190 receives external power or provides internal power and supply the appropriate power required for operating respective elements and components included in the watch-type mobile terminal 100 under the control of the control unit 180. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. According to the present embodiment, the power supply unit 190 may receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

First, the communication system may use mutually different wireless interfaces and/or physical layers. Examples of such air interfaces utilized by the communication systems include Frequency Division Multiple Access (FDMA), Time Division Multiple Access (TDMA), Code Division Multiple Access (CDMA), and Universal Mobile Telecommunications System (UMTS), the Long Term Evolution (LTE) of the UMTS, the Global System for Mobile Communications (GSM), and the like.

By way of non-limiting example only, further description will relate to a CDMA communication system, but such teachings apply equally to other system types including Orthogonal Frequency Division Multiplexing (OFDM) wireless communication as well as the CDMA wireless communication system.

A CDMA wireless communication system is shown having at least one terminal 100, at least one base station (BS) (which is named Node B or Evolved Node B), at least one of base station controllers (BSCs), and a mobile switching center (MSC). The MSC is configured to interface with a conventional Public Switch Telephone Network (PSTN). The MSC is also configured to interface with the BSCs. The BSCs are coupled to the base stations via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs may be included in the CDMA wireless communication system.

Each base station may include one or more sectors, each sector having an omni-directional antenna or an antenna pointed in a particular direction radially away from the BS. Alternatively, each sector may include two or more different antennas. Each BS may be configured to support a plurality of frequency assignments, with each frequency assignment having a particular spectrum (e.g., 1.25 MHz, 5 MHz, etc.).

The intersection of sector and frequency assignment may be referred to as a CDMA channel. The BS may also be referred to as Base Station Transceiver Subsystems (BTSs). In some cases, the term “base station” may be used to refer collectively to a BSC, and one or more BS. The base stations may also be denoted as “cell sites.” Alternatively, individual sectors of a specific base station may be referred to as cell sites.

A broadcasting transmitter (BT) transmits a broadcast signal to the terminals 100 operating within the system. The broadcast receiving module 111 as illustrated in FIG. 1 is typically configured inside the watch-type mobile terminal 100 to receive broadcast signals transmitted by the BT.

In addition, Global Positioning System (GPS) satellites may be connected with the CDMA wireless communication to identify the position of the watch-type mobile terminal 100. Such satellites 300 facilitate locating the position of at least one of plural watch-type mobile terminal 100. It is understood that useful position information may be obtained with greater or fewer satellites than two satellites. The position of the watch-type mobile terminal 100 may be tracked by using all technologies that is able to tract the location as well as the GPS tracking technology. In addition, at least one of the GPS satellites may alternatively or additionally be configured to provide satellite DMB transmissions.

The location information module 115 included in the mobile terminal is used for detecting, computing, or identifying the position of the mobile terminal, and may representatively include a Global Position System (GPS) module and a WiFi (Wireless Fidelity) module. If necessary, the location information module 115 may alternatively or additionally perform any of the other functions of the wireless communication unit 110 to obtain data on the position of the mobile terminal.

The GPS module 115 is able to precisely calculate current 3-dimensional position information based on at least one of longitude, latitude and altitude and direction (or orientation) by calculating distance information and precise time information from at least three satellites and then applying triangulation to the calculated information. Currently, location and time information are calculated using three satellites, and errors of the calculated location position and time information are then amended using another satellite. Besides, the GPS module 115 is able to calculate speed information by continuously calculating a real-time current location. However, it is difficult to measure the position of the mobile terminal by using the GPS module in a shadow area, such as an interior, of a satellite signal. Accordingly, in order to compensate for the positioning based on the GPS scheme, a WiFi positioning system (WPS) may be utilized.

The WiFi Positioning System (WPS) is a technology of tracking the position of the mobile terminal 100 by using a WiFi module included in the mobile terminal 100 and a wireless access point (AP) which transceives a wireless signal together the WiFi module. The WPS denotes a wireless local area network (WLAN) using WiFi

The WiFi positioning system may include a WiFi positioning server, the mobile terminal 100, a wireless AP connected with the mobile terminal 100, and a database having arbitrary wireless AP information stored therein.

The mobile terminal 100 in connection with the wireless AP may transmit a location information request message to the WiFi positioning system.

A WiFi positioning server extracts information of a wireless AP connected with the mobile terminal 100 based on a location information request message (or signal) of the mobile terminal 100. The information of the wireless AP connected with the mobile terminal 100 may be transmitted to the Wi-Fi positioning server through the mobile terminal 100 or may be transmitted from the wireless AP to the Wi-Fi location server.

The information of the wireless AP to be extracted based on the location information request message of the mobile terminal 100 includes a MAC address, an SSID (Service Set Identification), a Received Signal Strength Indicator (RSSI), a Reference Signal Received Power (RSRP), Reference Signal Received Quality (RSRQ), channel information, privacy, a network type, signal strength, and noise strength.

The WiFi positioning server may receive the information of the wireless AP connected to the mobile terminal 100 as described above, and may extract wireless AP information corresponding to the wireless AP connected to the mobile terminal from the pre-established database. The information of any wireless APs stored in the database may be information such as MAC address, SSID, channel information, Privacy, Network type, latitude and longitude coordinates of the wireless AP, the name of building at which the wireless AP is located, the floor number of the building, the detailed indoor location information (GPS coordinate available) of the building, an AP owner's address, a phone number, and the like. In this case, in order to remove wireless APs provided using a mobile AP or an illegal MAC address during a location determining process, the Wi-Fi positioning server may extract only a predetermined number of wireless AP information in order of high RSSI.

Then, the Wi-Fi positioning server may extract (analyze) location information of the mobile terminal 100 using at least one wireless AP information extracted from the database. The location information of the mobile terminal 100 may be extracted (or analyzed) by comparing the included information and the received wireless AP information.

A method for extracting (analyzing) location information of the mobile terminal 100 may include a Cell-ID method, a fingerprint method, a trigonometry method, a landmark method, and the like.

The Cell-ID method is used to determine a position of a wireless AP having the largest signal strength, among peripheral wireless AP information collected by the mobile terminal, as a position of the mobile terminal. The Cell-ID method is an implementation that is minimally complex, does not require additional costs, and location information may be rapidly acquired. However, in the Cell-ID method, the precision of positioning may fall below a desired threshold when the installation density of wireless APs is low.

The fingerprint method is used to collect signal strength information by selecting a reference position from a service area, and to track a position of a mobile terminal using the signal strength information transmitted from the mobile terminal based on the collected information. In order to use the fingerprint method, it is necessary for the characteristics of radio signals to be pre-stored in the form of a database.

The trigonometry method is used to calculate a position of a mobile terminal based on a distance between coordinates of at least three wireless APs and the mobile terminal. In order to measure the distance between the mobile terminal and the wireless APs, signal strength may be converted into distance information, Time of Arrival (ToA), Time Difference of Arrival (TDoA), Angle of Arrival (AoA), or the like may be taken for transmitted wireless signals.

The landmark method is used to measure a position of the mobile terminal using a known landmark transmitter.

In addition to these position location methods, various algorithms may be used to extract (analyze) location information of a mobile terminal.

Such extracted location information of the mobile terminal 100 may be transmitted to the mobile terminal 100 through the Wi-Fi positioning server, thereby acquiring location information of the mobile terminal 100.

The mobile terminal 100 may acquire location information by being connected with at least one wireless AP. The number of wireless APs required to acquire location information of the mobile terminal 100 may be variously changed according to a wireless communication environment within which the mobile terminal 100 is positioned.

Various embodiments described herein may be implemented in a computer-readable medium, a machine-readable medium, or similar medium using, for example, software, hardware, or any combination thereof.

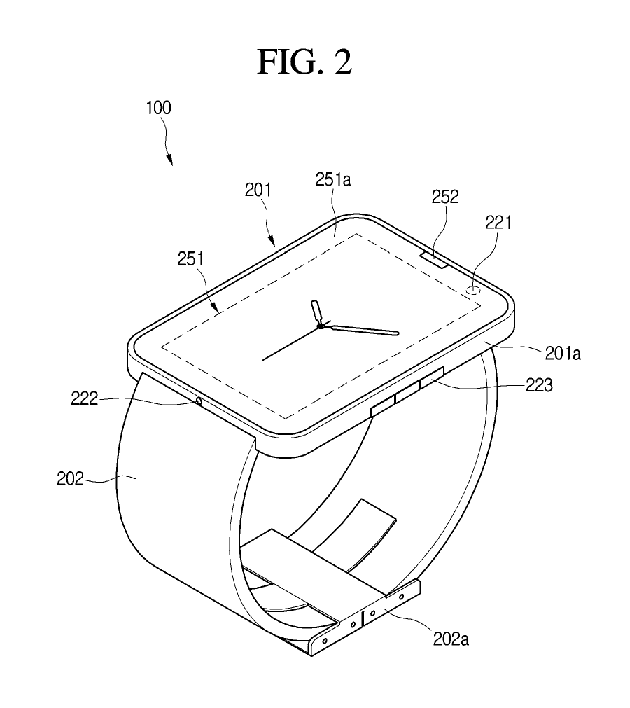

FIG. 2 is a perspective view illustrating one example of the watch-type mobile terminal related to the present invention.

The watch-type mobile terminal 100 illustrated in FIG. 2 may include all components included in FIG. 1.

The display unit 251 of the watch-type mobile terminal 100 illustrated in FIG. 2 may have a circular shape, but the present invention is not limited thereto. The display unit 251 may have an oval shape or a rectangular shape. The shape of the display unit 251 of the present invention may have various shapes sufficient to provide a visually good image for a user and to help the user manipulate the display unit 251.

Referring to FIG. 2, the watch-type mobile terminal 100 includes a main body 201 including the display unit 251 and a band 202 coupled to the main body 201 and configured to be worn on the wrist. The display unit 251 may correspond to the touch screen 151 of FIG. 1.

The main body 201 includes a case that forms an outer appearance. As shown in drawing, the case may include a first case 201a and a second case 201b which define an internal space for receiving various electronic components. However, the present invention is not limited thereto, but one case is included to provide the internal space, so that the watch-type mobile terminal 100 may be realized in the form of a unibody.

The watch-type mobile terminal 100 may be configured to enable wireless communication, and the main body 201 may be equipped with an antenna for wireless communication. Meanwhile, the performance of the antenna may be enhanced through the case. For example, a case including a conductive material may be configured to electrically be connected with the antenna and thus to expand the ground or a radiation area.

The display unit 251 may be disposed on the front surface of the main body 201 to output information. The display unit 251 may include a touch sensor so that the display unit 251 may be realized as a touch screen. As illustrated in drawings, a window 251a of the display unit 251 may be mounted on the first case 201a to form a front surface of a terminal body together with the first case 201a. The case may be referred to as a bezel.

The main body 201 may include a sound output unit 252, a camera 221, a microphone 222, a user input unit 223, and the like. In the case that the display unit 251 is realized as a touch screen, the display unit 251 may serve as a user input unit 223. Accordingly, the main body 201 may not have a separate key.

The band 202 is worn on the wrist to surround a wrist, and may be formed of a flexible material for easy wearing. For example, the band 202 may be formed of leather, rubber, silicone, synthetic resin material, or the like. In addition, the band 210 is provided detachably from the main body 201. Accordingly, the band 202 may be replaceable with various shapes of bands according to the preferences of a user.

Meanwhile, the band 202 may be used to expand the performance of the antenna. For example, the band 202 may include a ground extension part (not illustrated) that is electrically connected to the antenna to expand the ground area.

The band 202 may include a fastener 202a. The fastener 202a may be by a buckle, a snap-fit hook structure, or Velcro (trademark), and may include a section having elasticity or elastic material. The present drawing illustrates an example that the fastener 202a is realized in the shape of a buckle.

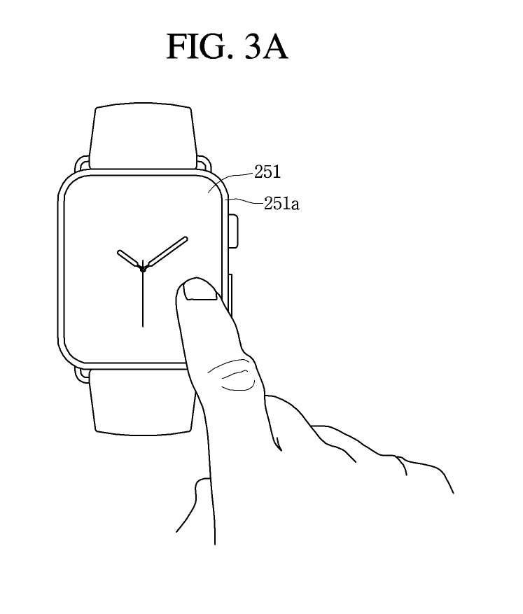

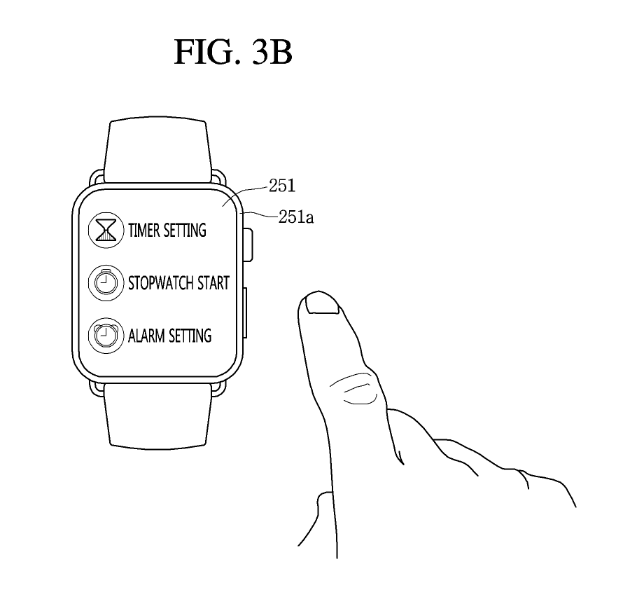

FIGS. 3a and 3b are diagrams illustrating touch input in a general watch type mobile terminal.

The display unit 251 is implemented by a touchscreen to display execution screen information of an application program executed in the watch type mobile terminal 100 or UI or GUI information according to such execution screen information. In this case, a user may control the watch type mobile terminal 100 by touch input of the UI or the GUI.

The watch type mobile terminal 100 is restricted in the size of the display unit 251 due to the properties of a device worn on a wrist. In general, the size of the display unit 251 is small and the size of the UI and GUI displayed on the display unit 251 is also small.

Accordingly, when the user touches the display unit 251 with a finger thereof, as shown in FIG. 3a, the finger hides the most part of the display unit 251. Therefore, the user may erroneously touch an unintended UI or GUI or have a difficulty of touching a UI or GUI having a small size.

Due to such problems, the display unit 251 displays a UI or GUI having a predetermined size or more. As the size of the UI or GUI increases, the number of UIs or GUIs displayed on the display unit 251 decreases. Referring to FIG. 3b, only a GUI list having three items is displayed on the display unit 251.

In the watch type mobile terminal 100 including the display unit 251 having the small size, it is difficult to control the terminal using an existing touch input method. Accordingly, there is a need for a new input method instead of the existing touch input method.

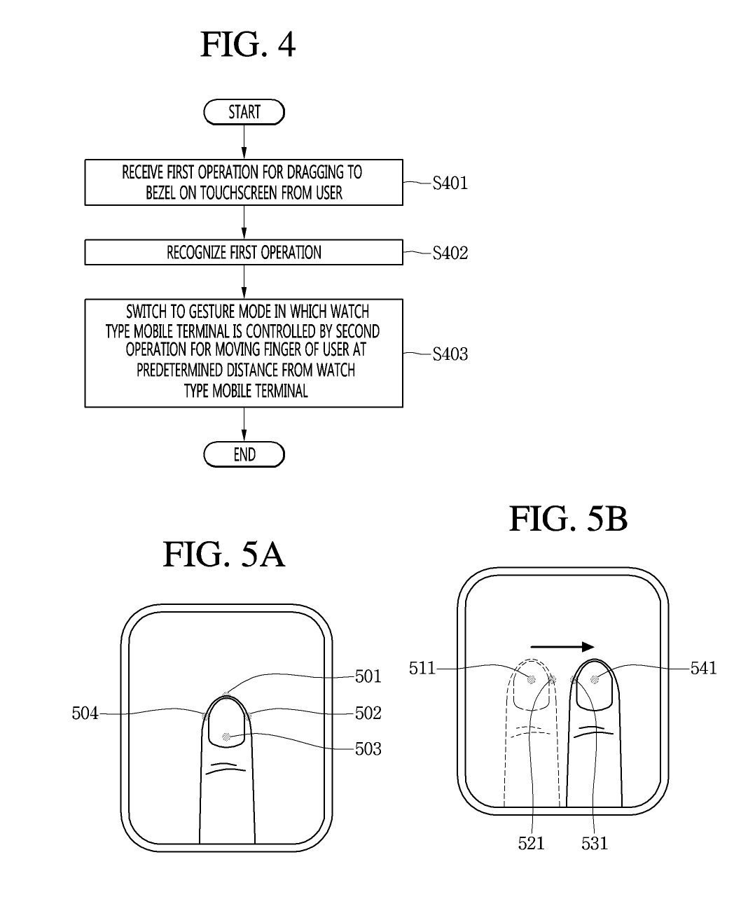

FIG. 4 is a flowchart illustrating a method of operating a watch type mobile terminal according to an embodiment of the present invention.

The display unit 251 of the watch type mobile terminal 100 receives first operation for dragging to a bezel on a touchscreen from a user (S401).

The first operation may be gesture mode activation operation for switching to a gesture mode defined in the present invention.

According one embodiment, the gesture mode activation operation may be operation for dragging a finger toward the bezel on the touchscreen. To this end, the display unit 251 may be implemented by a touchscreen and a window 251a, in which the display unit 251 is mounted, may be implemented by the bezel. Meanwhile, the bezel surrounds the border of the touchscreen and may be configured integrally with the touchscreen. In this case, the display unit 251 may include the touchscreen and the bezel.

In addition, according to another embodiment, the gesture mode activation operation may be defined as operation for deviating from the touchscreen by a predetermined distance.

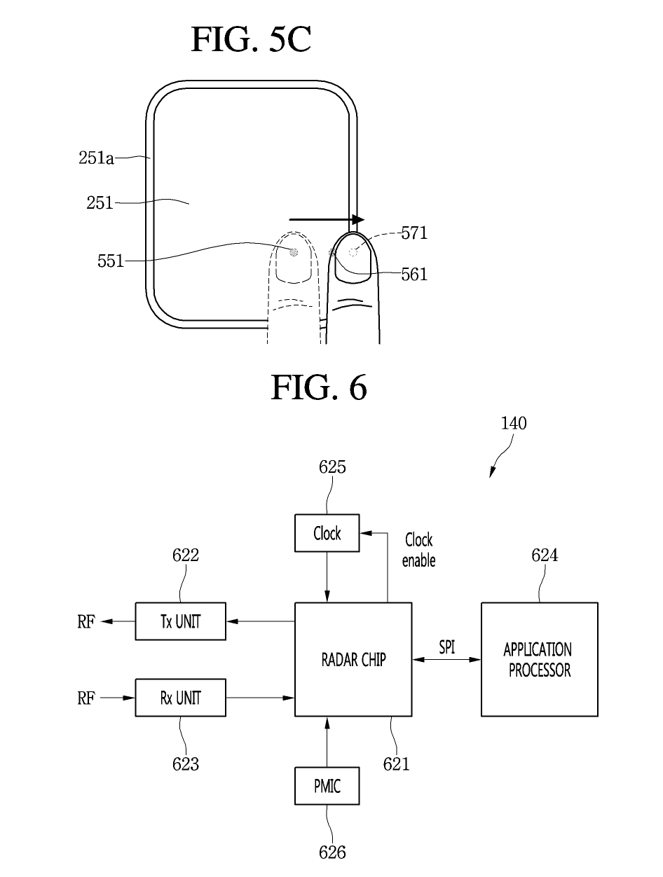

Meanwhile, according to another embodiment of the present invention, the gesture mode activation operation is defined differently from the above-described embodiment. Any operation which may be intentionally input by the user and may be recognized to be distinguished from other operations may be defined as a gesture mode activation mode according to another embodiment of the present invention. The gesture mode activation operation will be described below with reference to FIG. 5c.

The control unit 180 of the watch type mobile terminal 100 recognizes the first operation (S402). To this end, the control unit 180 may drive the touchscreen to recognize touch operation and drag operation input to the touchscreen and recognize the first operation when the first operation is input to the display unit 251.

When the first operation is recognized, the control unit 180 of the watch type mobile terminal 100 switches to a gesture mode in which the watch type mobile terminal 100 is controlled by second operation for moving the finger of the user at a predetermined distance from the watch type mobile terminal 100 (S403).

The second operation may be a gesture. The gesture is defined as a predetermined type of operation capable of controlling the watch type mobile terminal 100 in the gesture mode.

According to one embodiment, the gesture may be operation for moving a thumb and an index finger of the user at the predetermined distance from the watch type mobile terminal 100 without touching the touchscreen. Specifically, the gesture may be operation for rubbing the index finger with the thumb in a left-and-right direction or an up-and-down direction or operation for rubbing the index finger with the thumb while rotating in a horizontal plane or a vertical plane.

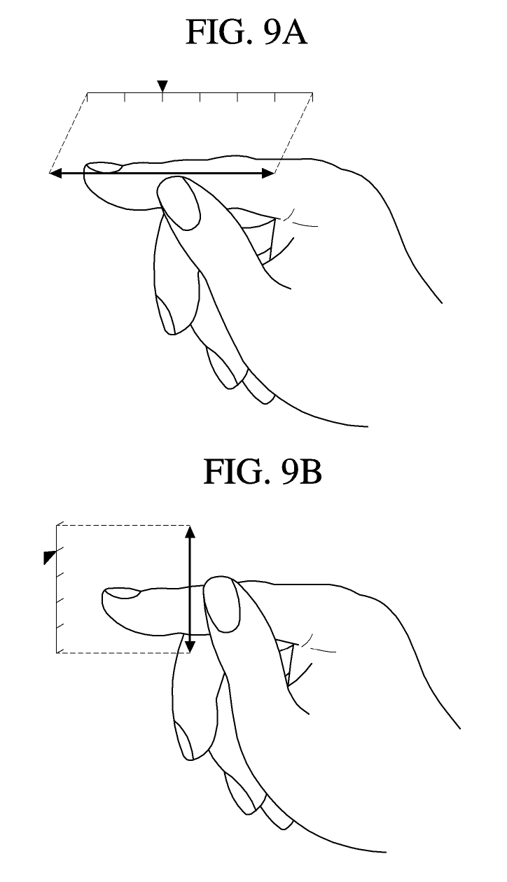

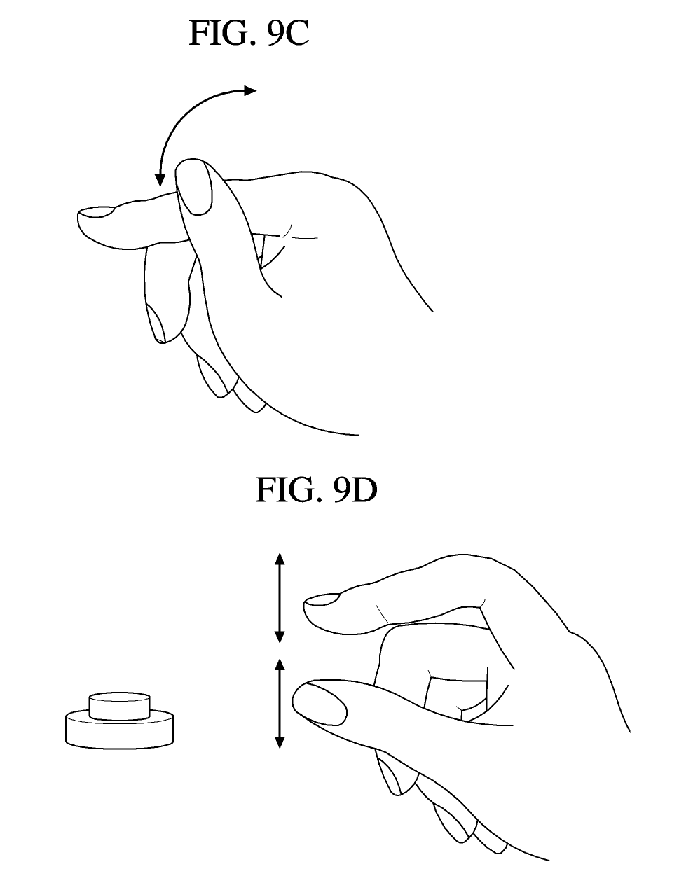

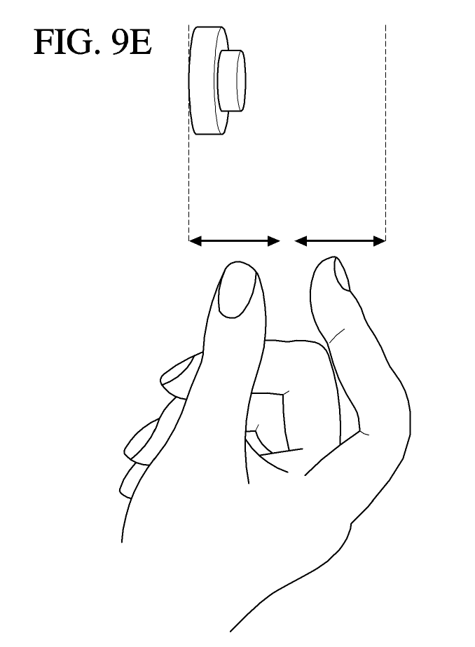

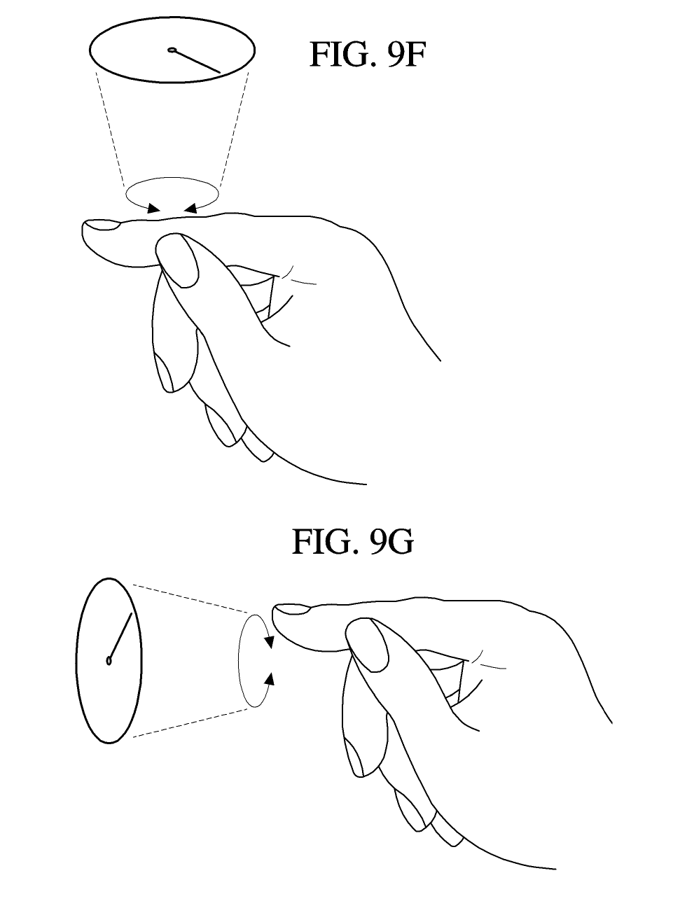

The gesture will be described in detail below with reference to FIGS. 9a to 9g.

In this case, the gesture may be recognized by the sensing unit 140. According to one embodiment, the sensing unit 140 may transmit an RF signal toward the finger of the user and analyze the pattern of the RF signal reflected from the finger, thereby recognizing the gesture. The process of recognizing the gesture using the sensing unit 140 will be described below with reference to FIG. 6.

Meanwhile, when the gesture mode activation operation is input to switch the input mode of the watch type mobile terminal 100 to the gesture mode, the control unit 180 controls the watch type mobile terminal 100 according to the gesture of the user.

According to one embodiment, the control unit 180 may perform control operation for controlling playback time point control, playback volume level control, zoom-in/out, page turning, etc. in correspondence with the gesture, if the gesture may be operation for rubbing the index finger with the thumb in the left-and-right direction or the up-and-down direction or operation for rubbing the index finger with the thumb while rotating in a horizontal plane or a vertical plane.

According to another embodiment, the control unit 180 may increase the number of contents of a list displayed on the display unit 251, upon switching to the gesture mode.

According to another embodiment, the control unit 180 may display at least one of a progress bar for controlling a playback time and a volume bar for controlling a playback volume level on the display unit 251, if any one of a moving image or music application is executed upon switching to the gesture mode.

Meanwhile, the control unit 180 may maintain the gesture mode until touch operation is input to the touchscreen, upon switching to the gesture mode.

FIGS. 5a to 5c are diagrams illustrating switching of three input modes of a watch type mobile terminal according to an embodiment of the present invention.

The watch type mobile terminal 100 according to the embodiment of the present invention may operate in three input modes. To this end, switching to the three input modes, that is, a touch mode, a drag mode and a gesture mode, is defined as follows.

FIG. 5a shows switching to the touch mode. If the user contacts (or clicks) the touchscreen, the watch type mobile terminal 100 may recognize a plurality of contact points 501, 502, 503 and 504 simultaneously contacting the touchscreen with an irregular pattern in a predetermined region. In this case, the watch type mobile terminal 100 recognizes that the user inputs the touch operation and switches to the touch mode.

FIG. 5b shows switching to the drag mode. If the user drags a finger thereof on the touchscreen, the watch type mobile terminal 100 may recognize a plurality of contact points 511, 521, 531 and 541 sequentially contacting the touchscreen along a predetermined trajectory. In this case, the watch type mobile terminal 100 recognizes that the user inputs the drag operation and switches to the drag mode.

FIG. 5c shows switching to the gesture mode. When the user drags a finger thereof on the touchscreen 251 toward the bezel 251a to deviate from the touchscreen 251, the watch type mobile terminal 100 may recognize that a plurality of contact points 551, 561 and 571 sequentially moves from the touchscreen 251 toward the bezel 251a along the predetermined trajectory in a state of contacting the touchscreen. In this case, the watch type mobile terminal may recognize only the contact points 551 and 561 located on the touchscreen 251 and may not recognize the contract point 571 located on the bezel 251a. However, when the predetermined trajectory continues to the boundary between the touchscreen 251 and the bezel 251a, the watch type mobile terminal 100 recognizes that the user inputs the gesture mode activation operation and switches to the gesture mode.

According to one embodiment, switching to any one of the touch mode, the drag mode and the gesture mode may be performed based on the input time and movement distance of the touch operation. For example, if the touch operation has a movement distance change of less than 2 mm within a time of 180 ms, the user may be regarded as having intention of touch (or click) and switching to the touch mode may be performed and, if the touch operation has a movement distance change of 2 mm or more within a time of 180 ms, the user may be regarded as having intention of drag (or flick) and switching to the drag mode may be performed. In addition, when the touch operation is performed to exceed the boundary between the touchscreen and the bezel by 5 mm or more, the user may be regarded as having intention of activating the gesture mode and switching to the gesture mode may be performed.

FIG. 6 is a diagram illustrating a process of recognizing a gesture according to an embodiment of the present invention.

The sensing unit 140 sends a wave, that is, a radio frequency (RF) signal, toward a target object and receives a reflected signal. In this case, the sensing unit 140 analyzes the pattern of an Rx signal returned after an emitted Tx signal reflects at a target object and senses the shape and location of the target object.

The gesture defined in the present invention may be recognized by radar recognition technology. To this end, in the present invention, a subminiature radar chip 621 is mounted in the sensing unit 140 and the radar chip 621 recognizes a distance to the finger of the user and recognizes fine motion of the finger.

Referring to FIG. 6, the sensing unit 140 may include a radar chip 621, a Tx unit 622, an Rx unit 623, an application processor 624, a clock 625 and a PMIC 626.

The radar chip 621 generates and amplifies an RF signal, transmits the amplified RF signal through the Tx unit 622, performs noise filtering with respect to an RF signal received through the Rx unit 623, converts the RF signal into digital data, and transmits the digital data to the application processor 624.

To this end, the radar chip 621 and the application processor 624 may perform serial peripheral interface (SPI) communication. SPI communication refers to a communication method of exchanging data between chips (ICs), that is, a communication method of exchanging data between small peripheral devices such as chips.

The application processor 624 extracts a specific gesture through a machine learning scheme and determines which gesture is made. That is, since the RF pattern of the gesture is changed according to the shape and direction of an antenna, the specific gesture may be defined through the machine learning scheme based on big data of the specific gesture.

The Tx unit 622 transmits the RF signal generated by the radar chip 621 toward a target object.

The Rx unit 623 receives the RF signal reflected from the target object.

The clock 625 supplies a clock signal to the radar chip 621 when a clock enable signal is received from the radar chip 621.

The PMIC 626 is a power management IC (PMIC) for supplying power to the radar chip 621.

In the three input modes, that is, the touch mode, the drag mode and the gesture mode, of the watch type mobile terminal 100 according to the embodiment of the present invention, the components operate as follows.

In the touch mode, in order to minimize current consumption, the radar chip 621 is shut down. Accordingly, power is not supplied to the radar chip 621. In this case, SPI communication between the application processor 624 and the radar chip 621 is inactivated and thus the clock 625 and the RF signal are disabled.

The drag mode is a preparation step for rapidly performing operation upon switching to the gesture mode, and, in this case, the radar chip 621 is maintained in a ready state. Accordingly, power is supplied to the radar chip 621. In this case, SPI communication between the application processor 624 and the radar chip 621 is activated and thus the clock 625 is enabled. However, since recognition using the RF signal is not performed, the RF signal is disabled.

In the gesture mode, in order to recognize a gesture, the radar chip 621 is maintained in an enabled state. Accordingly, power is supplied to the radar chip 621. In this case, SPI communication between the application processor 624 and the radar chip 621 is activated and thus the clock 625 is enabled. Since recognition using the RF signal is performed, the RF signal is also enabled.

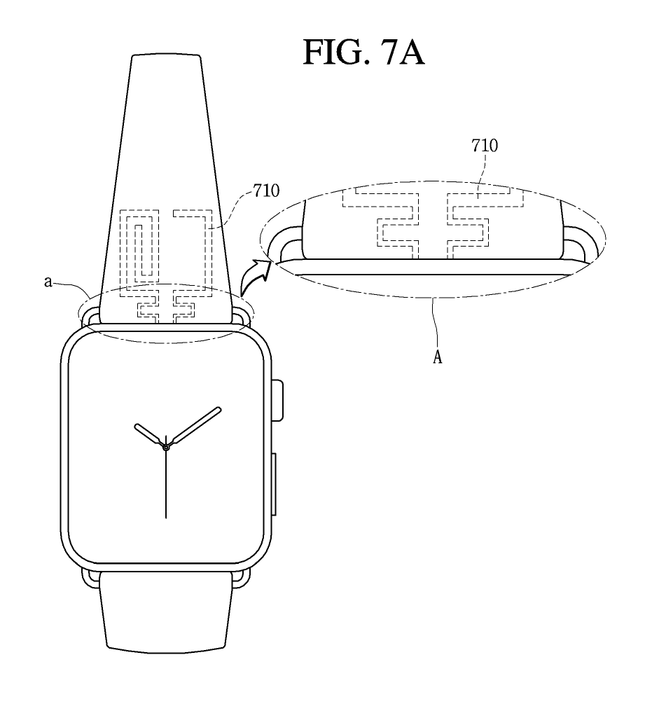

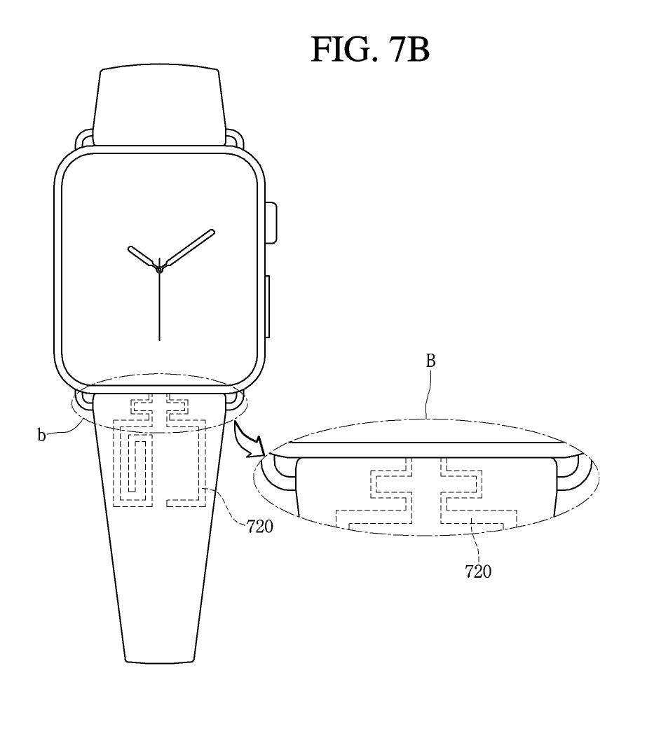

FIGS. 7a and 7b are diagrams showing the configuration of an antenna mounted in a watch type mobile terminal according to an embodiment of the present invention.

The watch type mobile terminal 100 includes a main body including a display unit 251 and a strap connected to the main body and capable of being worn on a wrist. The watch type mobile terminal 100 may perform wireless communication and thus include an antenna for transmitting and receiving RF signals. Specifically, the antenna may be mounted in an upper strap or a lower strap of the watch type mobile terminal.

Referring to FIG. 7a, a part A obtained by enlarging a part a in which an upper end of the main body and an upper strap are connected is shown. Referring to the part A, the antenna 710 is mounted in the upper strap.

Referring to FIG. 7b, a part B obtained by enlarging a part b in which a lower end of the main body and a lower strap are connected is shown. Referring to the part B, the antenna 720 is mounted in the lower strap.

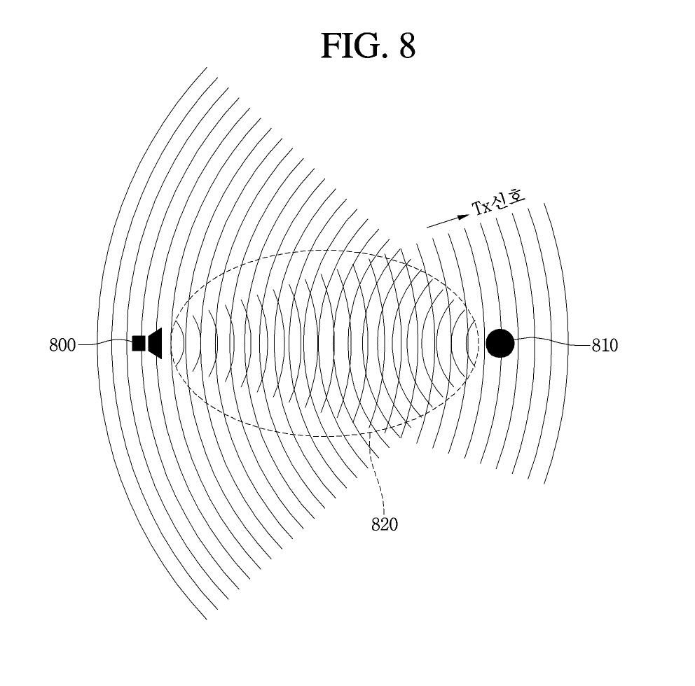

FIG. 8 is a diagram illustrating recognition of motion of a user using an RF signal according to an embodiment of the present invention.

In the present invention, RF spectrum is used to recognize motion or gesture of a user. Specifically, an RF signal is transmitted toward a target object, a reflected signal is received, and the pattern of the RF signal returned after the emitted RF signal is reflected at the target object is analyzed.

Referring to FIG. 8, in order to recognize motion or gesture of a specific object 810, a device 800 transmits a Tx signal. When the Tx signal is reflected at the specific object 810 and returned, the device 800 extracts motion or gesture from a reflection pattern 820 included in an Rx signal.

Motion recognition based on an RF signal uses a frequency domain of 5 GHz to 60 GHz and has a field of view (FOV) of 160 to 180 degrees. Motion recognition using the RF signal may be performed under plastic having a thickness of 10 mm and cloth having a thickness of 20 mm and overlap between hand gestures may be recognized. Accordingly, motion recognition using RF signals may perform fine control unlike existing IR type motion recognition.

FIGS. 9a to 9g are diagrams showing a gesture according to an embodiment of the present invention.

A gesture according to one embodiment of the present invention may be a gesture of moving a thumb and an index finger of a user at a predetermined distance from the watch type mobile terminal 100 without touching a touchscreen. Specifically, a gesture may be a gesture of rubbing an index finger with a thumb in a left-and-right direction or an up-and-down direction or operation for rubbing the index finger with the thumb while rotating in a horizontal plane or a vertical plane.

Referring to FIG. 9a, the user rubs the index finger with the thumb from side to side in a state in which the thumb and the index finger meet. Time control may be performed in correspondence with motion of the thumb moving from side to side. Specifically, a progress bar indicating a playback progress state of a moving image or music may move back and forth. For example, when the thumb moves to the right, the playback time of the moving image or music moves to the future and, when the thumb moves to the left, the playback time of the moving image or music moves to the past.

Referring to FIG. 9b, the user rubs the index finger with the thumb up and down in a state in which the thumb and the index finger meet. Quantitative control may be performed in correspondence with motion of the thumb moving up and down. Specifically, a volume bar indicating a playback volume level of a moving image or music may move up and down. For example, when the thumb moves up, the playback volume increases and, when the thumb moves down, the playback time decreases.

Referring to FIG. 9c, the user may flick the index finger with the thumb in a state in which the thumb and the index finger meet. An application may be finished or selected or entry into an application may be performed in correspondence with motion of the flicked thumb.

Referring to FIG. 9d, the user may move the thumb and the index finger up and down in a state in which the thumb and the index finger are separated from each other, thereby controlling a distance between the two fingers. Quantitative control may be performed in correspondence with the changed distance between the two fingers. Specifically, a volume bar indicating a playback volume level of a moving image or music may move up and down. For example, when the distance between the two fingers increases, the playback volume increases and, when the distance between the two fingers decreases, the playback time decreases.

Referring to FIG. 9e, the user may move the thumb and the index finger from side to side in a state in which the thumb and the index finger are separated from each other, thereby controlling a distance between the two fingers. Magnification control may be performed in correspondence with the changed distance between the two fingers. Specifically, a map magnification or a screen display magnification may be controlled. For example, when the distance between the two fingers increases, the map magnification may be increase or the screen may be zoomed in and, when the distance between the two fingers decreases, the map magnification may be decreased or the screen may be zoomed out.

Referring to FIG. 9f, the user makes a circle with the thumb in a horizontal direction of the index finger in a state in which the thumb and the index finger meet. Periodically repeated operation may be controlled in correspondence with circular motion in the horizontal direction. For example, the circle may be made in a clockwise direction to move the hands of a clock or to turn a page.

Referring to FIG. 9g, the user makes a circle with the thumb in a vertical direction of the index finger in a state in which the thumb and the index finger meet. Priority of an application may be controlled in correspondence with circular motion in the vertical direction. For example, an uppermost GUI among GUIs displayed on the display screen may be changed according to the circle made in the vertical direction.

According to such gestures, it is possible to easily control the watch type mobile terminal 100 outside the touch region. In addition, by moving a finger in a region outside a small display screen region, three control operations may be performed without restriction on screen size.

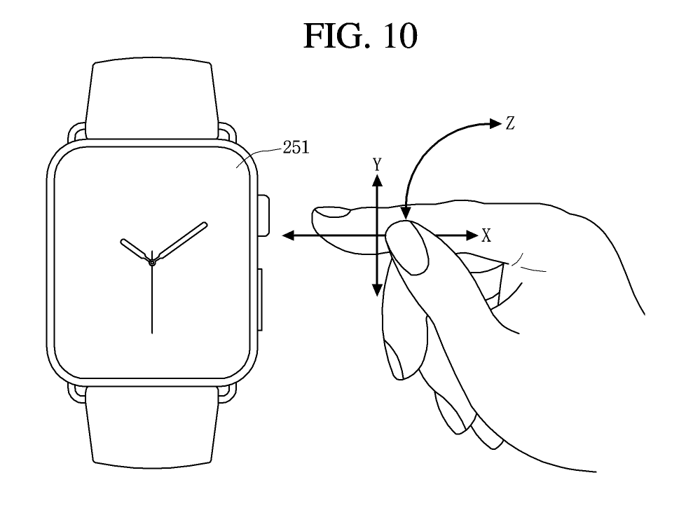

FIG. 10 is a diagram showing input of a gesture according to an embodiment of the present invention.

A user moves a thumb and an index finger at a predetermined distance from the watch type mobile terminal 100. Specifically, as shown in FIG. 10, the index finger may be rubbed with the thumb in a left-and-right (X) direction or in an up-and-down (Y) direction or the thumb may be obliquely flicked in a diagonal direction in a state in which the thumb and the index finger meet. The above-described gestures may be implemented by manipulating a volume knob, moving a slider or recognizing hand motion to manipulate a virtual tool. Therefore, the user may control the watch type mobile terminal 100 by making a hand gesture in the air without individually touching the watch type mobile terminal 100.

In an existing touch input method, touch input is restricted to a touch region, that is, a display region. Accordingly, in a device having a small display size, the device is not easily controlled through touch and a progress bar requiring fine adjustment is not displayed.

In a gesture mode according to an embodiment of the present invention, the watch type mobile terminal 100 may be controlled without touch of the touch region. That is, a gesture may be input in a wide region outside the touch region without being limited to the touch region. In this case, control may be performed without hiding a small touch region and a probability of causing malfunction due to the small size of the touch region is decreased. Further, since a gesture may be input in a wide region without restriction, fine control is possible.

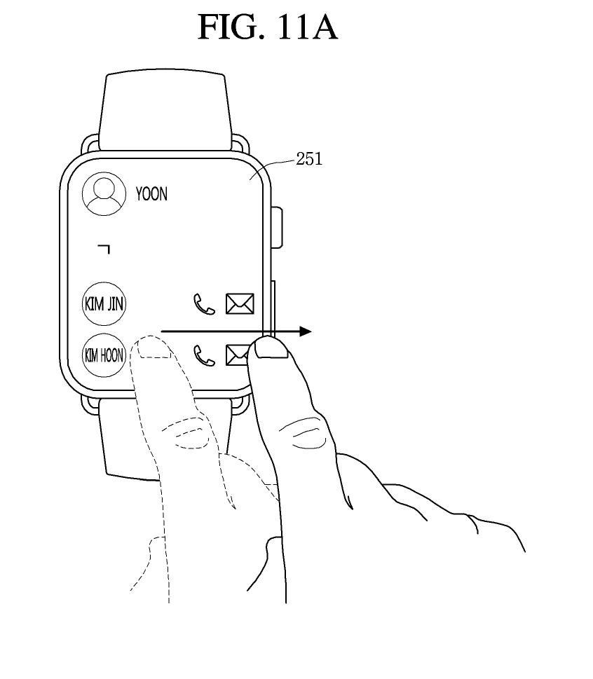

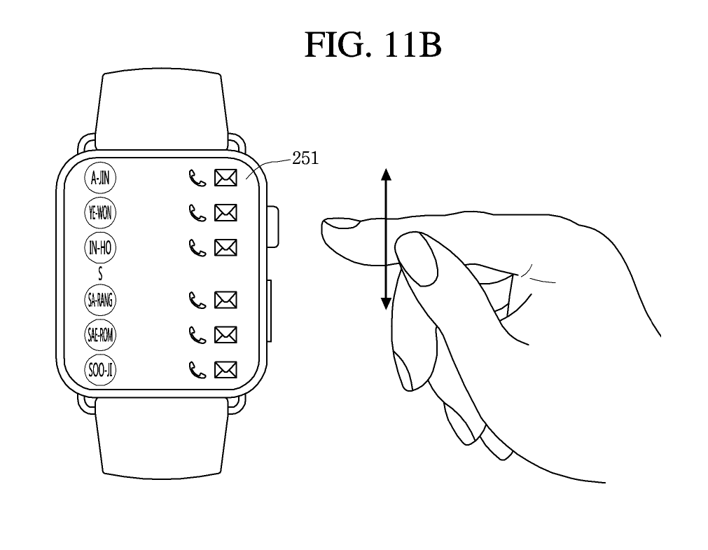

FIGS. 11a and 11b are diagrams illustrating control of a watch type mobile terminal by a gesture according to an embodiment of the present invention.

In FIG. 11a, assume that operation is performed in a touch mode or a drag mode. In this case, the number of GUIs displayed on the touchscreen 251 or the displayed content is restricted such that the user easily performs touch operation or drag operation. For example, referring to FIG. 11a, only two items of a list of phone numbers are displayed.

In this case, when the user drags the index finger on the touchscreen 251 toward a bezel to deviate from the touchscreen 251, the watch type mobile terminal 100 is switched to a gesture mode.

In the gesture mode, the user moves a finger in the air without touching the touchscreen to control the watch type mobile terminal 100. Accordingly, the size or number of GUIs necessary to facilitate touch operation of the user are not restricted. In addition, since fine motion of a finger may be recognized to perform fine control, more GUIs or items of a list may be displayed on the touchscreen. While only two items of the list of phone numbers are displayed in FIG. 11a, six items of the list of phone numbers are displayed in the gesture mode of FIG. 11b.

Meanwhile, as shown in FIG. 11b, the user may rub the index finger with the thumb in the up-and-down direction, thereby scrolling the list of phone numbers. Specifically, when the thumb is rubbed upward, the list is scrolled up and a lower end of the list is displayed and, when the thumb is rubbed downward, the list is scrolled down and an upper end of the list is displayed.

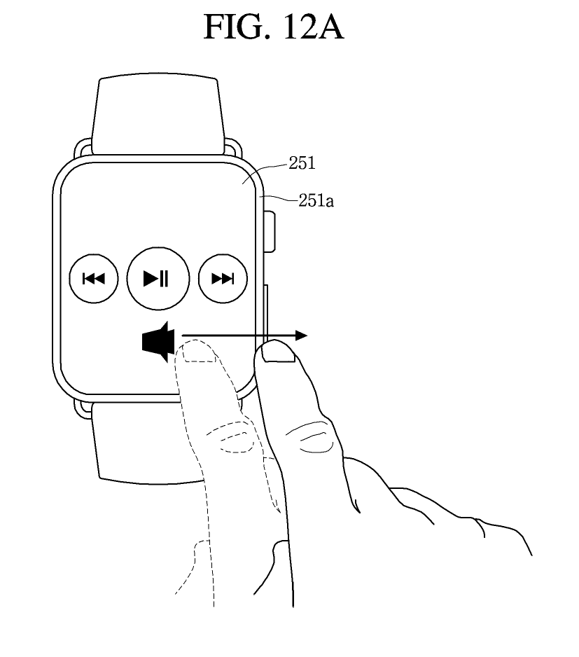

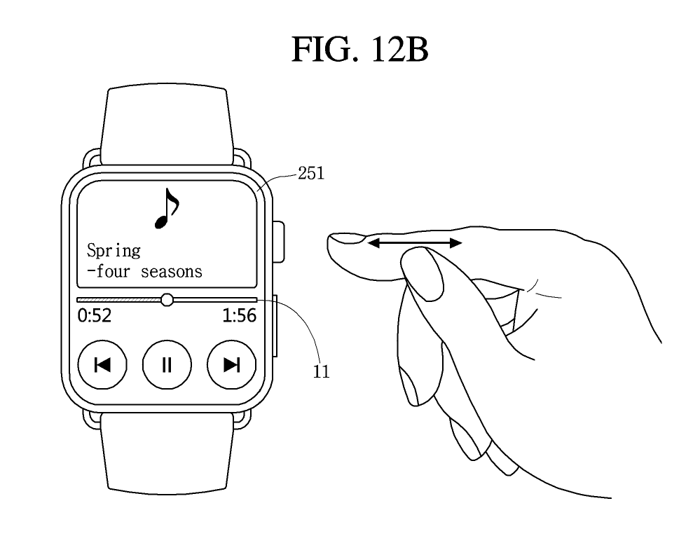

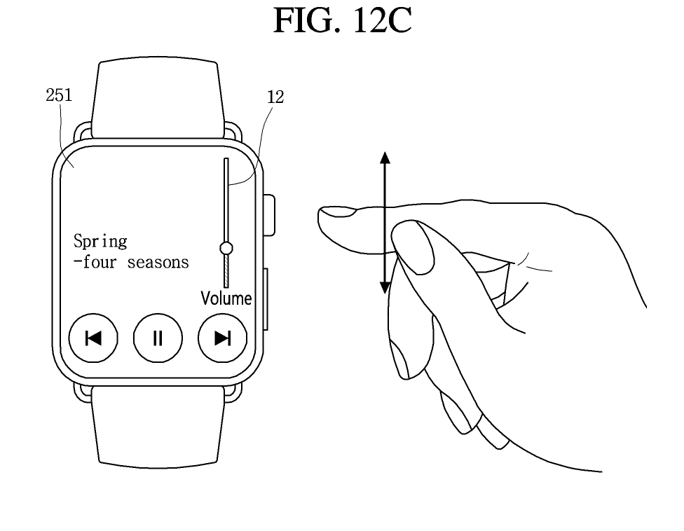

FIGS. 12a to 12c are diagrams illustrating control of a watch type mobile terminal by a gesture according to an embodiment of the present invention.

Assume that operation is performed in a touch mode or a drag mode in FIG. 12a and operation is performed in a gesture mode in FIGS. 12b and 12c.

In this case, since the size of the screen is small and thus it is difficult for the user to perform fine adjustment through touch operation or drag operation, a status bar such as a progress bar or a volume bar is not displayed. For example, referring to FIG. 12a, only GUIs for play/stop, fast forward and rewind are displayed, but the status bar is not displayed.

When the user inputs gesture mode activation operation by dragging the index finger on the touchscreen 251 toward the bezel 251a to deviate from the touchscreen 251, the watch type mobile terminal 100 is switched to the gesture mode.

In the gesture mode, fine adjustment through finger motion is possible. That is, since the user easily moves the finger without restriction on an input region outside the touch region, it is possible to adjust the status bar including various steps for fine adjustment. Accordingly, the progress bar or the volume bar is displayed on the touchscreen 251.

While only GUIs for play/stop, fast forward and rewind are displayed on the touchscreen in FIG. 12a, the progress bar 11 is displayed on the touchscreen 251 of FIG. 12b and the volume bar 12 is displayed on the touchscreen 251 of FIG. 12c.

As shown in FIG. 12b, the user rubs the index finger with the thumb in the left-and-right direction to move the progress bar 11 back and forth. Specifically, when the thumb is rubbed in the right direction, the progress bar 11 moves back and the playback time point of music moves back and, when the thumb is rubbed in the left direction, the progress bar 11 moves forth and the playback time point of music moves forth.

As shown in FIG. 12c, the user rubs the index finger with the thumb in the up-and-down direction to move the volume bar 12 up and down. Specifically, when the thumb is rubbed upward, the volume bar 12 moves upward to increase the playback volume and, when the thumb is rubbed downward, the volume bar 12 moves downward to decrease the playback volume.

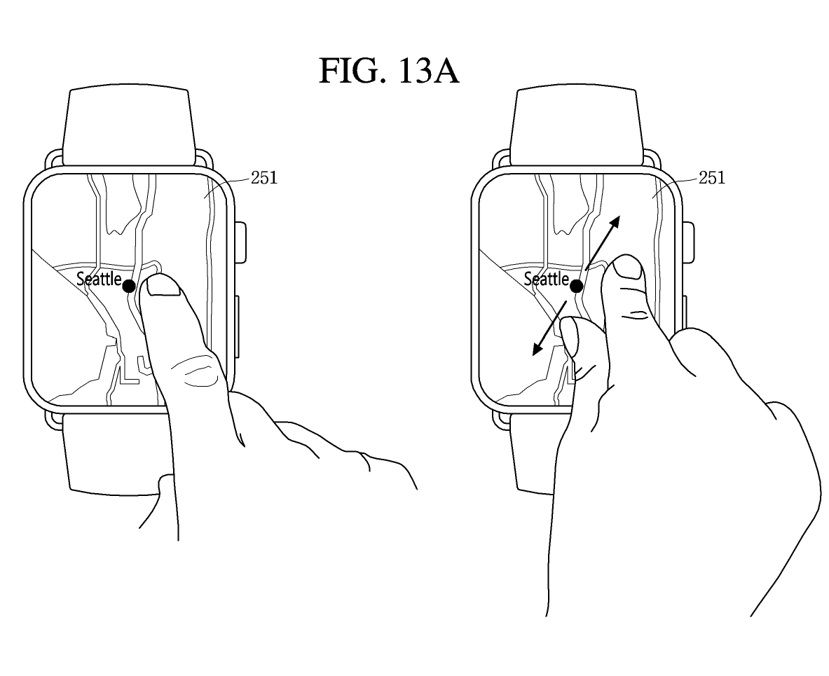

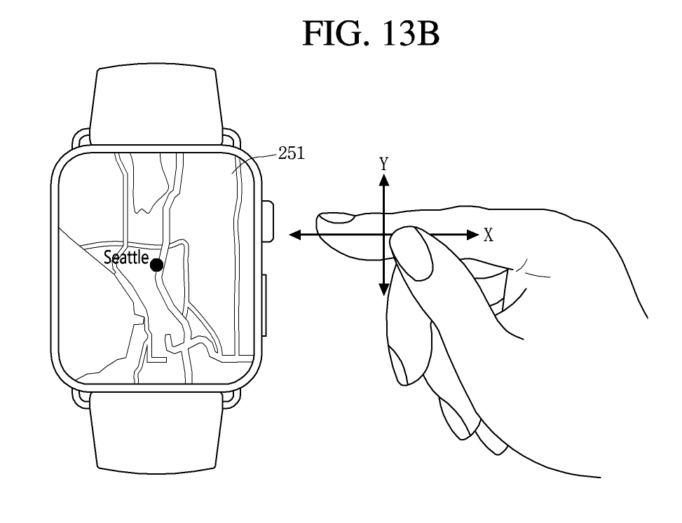

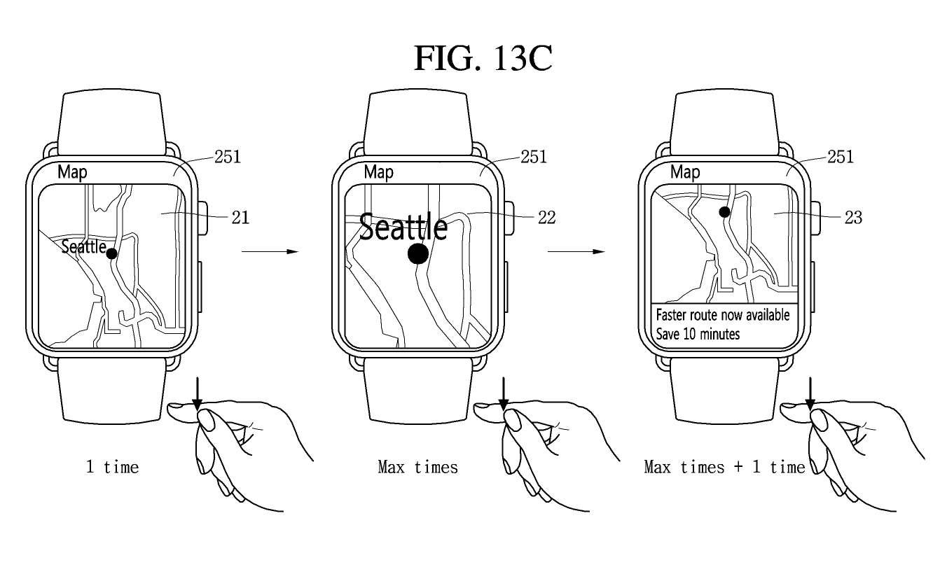

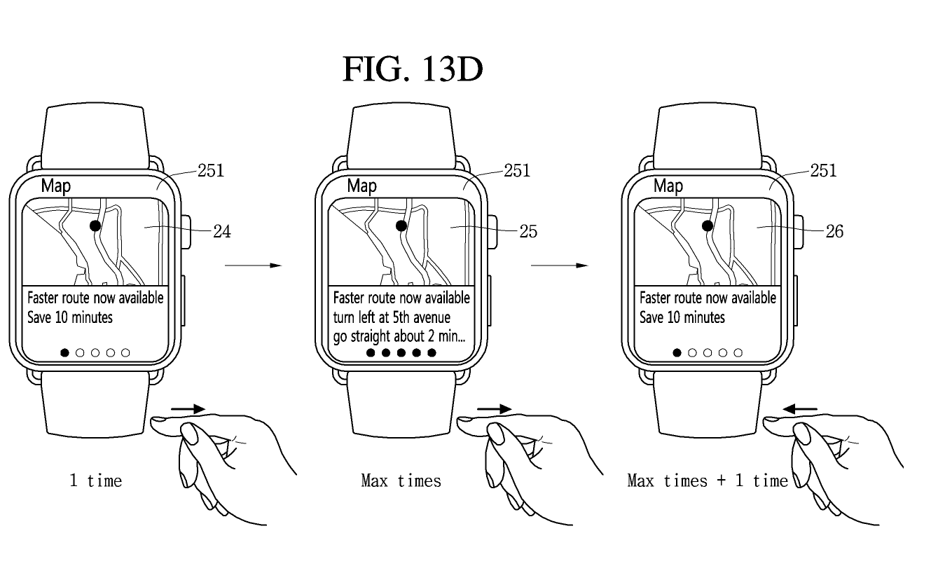

FIGS. 13a to 13d are diagrams illustrating a process of controlling a map application by a gesture according to an embodiment of the present invention.

In FIGS. 13a to 13d, assume that a map application is executed on the touchscreen of the watch type mobile terminal 100.

If the map application is executed in a general mobile terminal, since a display screen is large, a departure point and a destination are conveniently viewed at a glance. In this case, information on means of transportation may also be displayed, thereby increasing user convenience. However, in the case of the watch type mobile terminal 100, since the display screen is small, the departure point and the destination are not displayed on one screen and the user may not easily perform operation for zooming the map in or out or moving the map.

FIG. 13 shows operation in a touch mode or a drag mode. As shown at the left side of the figure, since the finger hides the most part of the touchscreen upon touch, it is difficult to accurately find a destination, a departure point and an arrival point on the map through touch operation.

As shown at the right side of the figure, it is difficult to zoom the map in or out due to the small screen size. In some cases, malfunction such as scroll up or down may be generated upon zooming the map in or out.

FIG. 13b shows operation in a gesture mode. The user rubs the index finger with the thumb in the left-and-right (X) direction or the up-and-down (Y) direction, thereby easily controlling the map application. Specifically, the index finger may be rubbed in the left-and-right (X) direction, thereby turning the pages of the displayed image. The index finger may be rubbed in the up-and-down (Y) direction, thereby zooming the map in or out on the screen.

FIG. 13c shows operation in a gesture mode. Referring to FIG. 13c, the user rubs the index finger with the thumb downward, thereby zooming the map in. As the user repeatedly performs the above operation several times, the place (the destination, the departure point or the arrival point) is gradually enlarged and displayed.

When the user rubs the index finger downward with the thumb once, the leftmost map screen 21 is displayed. As the map is zoomed in, the user may view the map of the place in greater detail.

When the user rubs the index finger downward by a maximum number of times until the map is maximally zoomed in, a maximally enlarged map is displayed like a middle map screen 22.

When the user rubs the index finger downward one more time in a state of maximally zooming the map in, a map with a detailed description of the place is displayed like a rightmost map screen 23. In this case, the detailed description may continue on multiple pages and a process of controlling the pages of the description will be described with reference to FIG. 13d.

Referring to FIG. 13d, the user may rub the index finger with the thumb from side to side to turn the pages of the detailed description. As the user repeatedly performs the above operation, the pages may be continuously turned backward or forward to display a last page or a first page.

When the user rubs the index finger to the right with the thumb once, the first page 24 of the detailed description is displayed as shown at the leftmost side of the figure. When the user repeats operation for rubbing the finger to the right, the pages of the detailed description are turned backward and, when the user repeats operation for rubbing the finger to the left, the pages of the detailed description are turned forward.

When the user rubs the index finger to the right by a maximum number of times until the last page 25 of the detailed description is displayed, the last page 25 of the detailed description is displayed as shown at the middle side of the figure.

When the user rubs the index finger to the left one more time in a state of displaying the last page of the detailed description, the first page 26 of the detailed description is displayed as shown at the rightmost side of the figure.

Meanwhile, when the user rubs the index finger upward with the thumb to zoom the screen out on the page shown in FIG. 13d, the screen on which the detailed description is displayed may be switched to the screen on which the map is displayed.

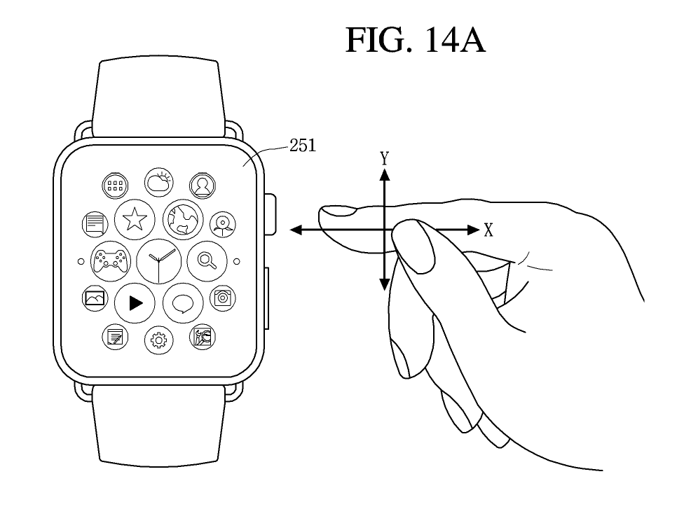

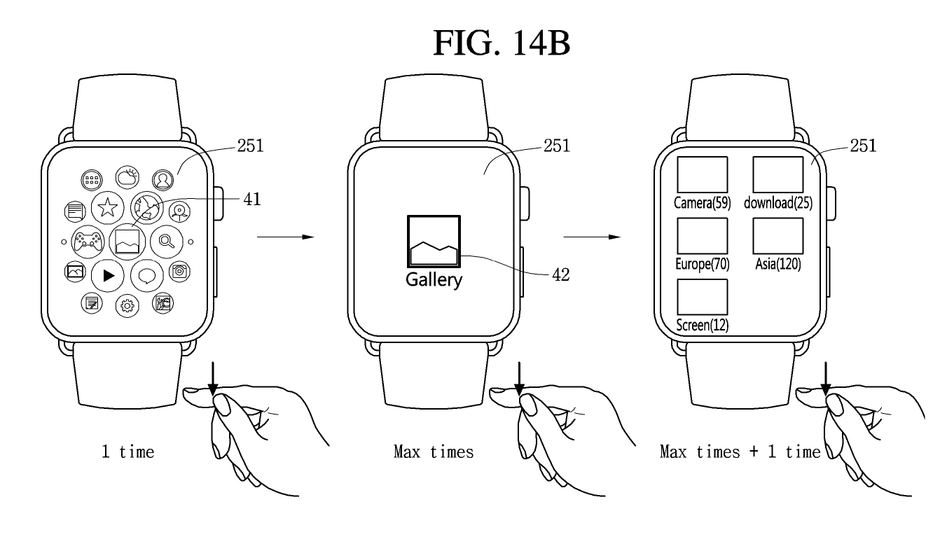

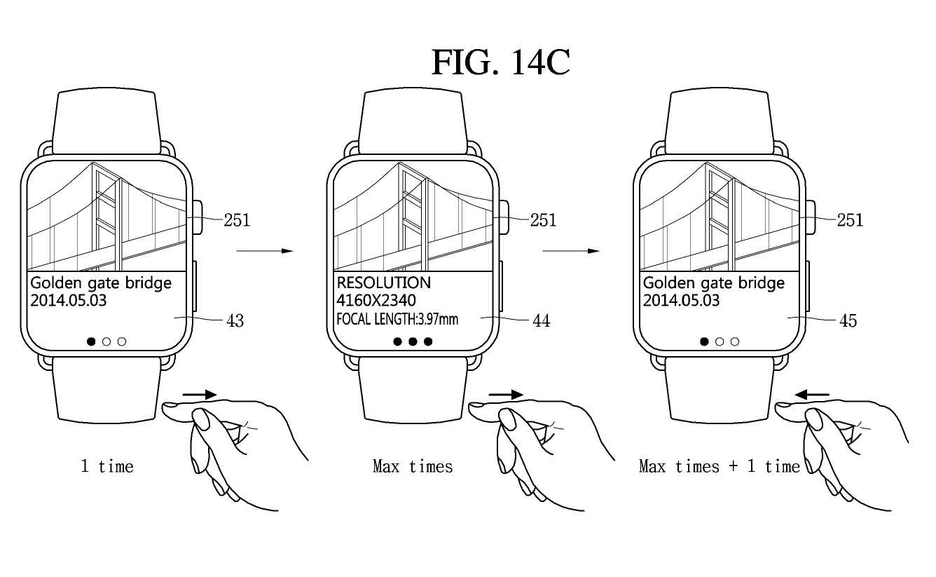

FIGS. 14a to 14c are diagrams illustrating a process of controlling a gallery application by a gesture according to an embodiment of the present invention.

In FIGS. 14a to 14c, assume that operation is performed in a gesture mode.

A mobile terminal may display a large number of GUIs on one screen. In this case, the user can conveniently view the GUIs to be controlled at a glance.

In contrast, the watch type mobile terminal 100 may display only a smaller number of GUIs due to restriction on screen size, as compared to the mobile terminal. Accordingly, there is a need for a method of more efficiently displaying and controlling GUIs in the watch type mobile terminal 100.

According to one embodiment, the watch type mobile terminal 100 may display a plurality of GUIs on the touchscreen 251 and the sizes of the GUIs may differ according to the location of the GUI.

Referring to FIG. 14a, the sizes of the displayed GUIs differ. Specifically, the size of the GUI located at the center of the screen is large and the size of the GUI located far away from the center of the screen is small. In this case, the user rubs the index finger with the thumb in the left-and-right (X) direction or the up-and-down (Y) direction, thereby easily controlling a gallery application. Specifically, the index finger may be rubbed in the left-and-right (X) direction, thereby turning the pages of the displayed information. In addition, the index finger may be rubbed in the up-and-down (Y) direction, thereby zooming the gallery application in or out.

Referring to the leftmost side of FIG. 14b, a GUI 41 corresponding to the gallery application is displayed at the center of the screen. In order to execute the gallery application, the user rubs the index finger downward with the thumb, thereby zooming the GUI 41 in. As the user repeats the above operation, the gallery application is gradually enlarged and displayed.

When the user rubs the index finger downward by a maximum number of times until the gallery application is selected, a GUI 14 corresponding to the gallery application is selected as shown at the middle side of FIG. 14b. In this case, a GUI corresponding to another application may disappear and only the GUI 42 corresponding to the gallery application may be enlarged and displayed on the screen.

When the user rubs the index finger downward one more time in a state of selecting the gallery application, the gallery application is executed and the main screen of the gallery application is displayed. Referring to the rightmost side of FIG. 14b, the main screen of the gallery application, that is, a summary of multiple photo folders, is displayed.

Meanwhile, if the gallery application is executed, detailed information of a selected photo may be displayed and controlled. This will be described with reference to FIG. 14c.

As shown in FIG. 14c, the user may rub the index finger with the thumb from side to side to turn the pages of the detailed description of the photos. As the user repeats the above operation several times, the pages are continuously turned backward or forward to display a last page or a first page.

When the user rubs the index finger to the right with the thumb once, a first page 43 of the detailed description is displayed on the screen as shown at the leftmost side of the figure. When the user repeats operation for rubbing the finger to the right, the pages of the detailed description may be turned backward and, when the user repeats operation for rubbing the finger to the left, the pages of the detailed description may be turned forward.

When the user rubs the index finger to the right by a maximum number of times until the last page is displayed, the last page 44 of the detailed description is displayed as shown at the middle side of the figure.

In this state, when the user rubs the index finger to the left with the thumb one more time, the first page 45 of the detailed description is displayed as shown at the rightmost side of the figure.

Meanwhile, when the user rubs the index finger upward with the thumb to zoom the gallery application out on the screens shown in FIG. 14c, the detailed description may disappear to return to the main screen on which the photos are displayed.

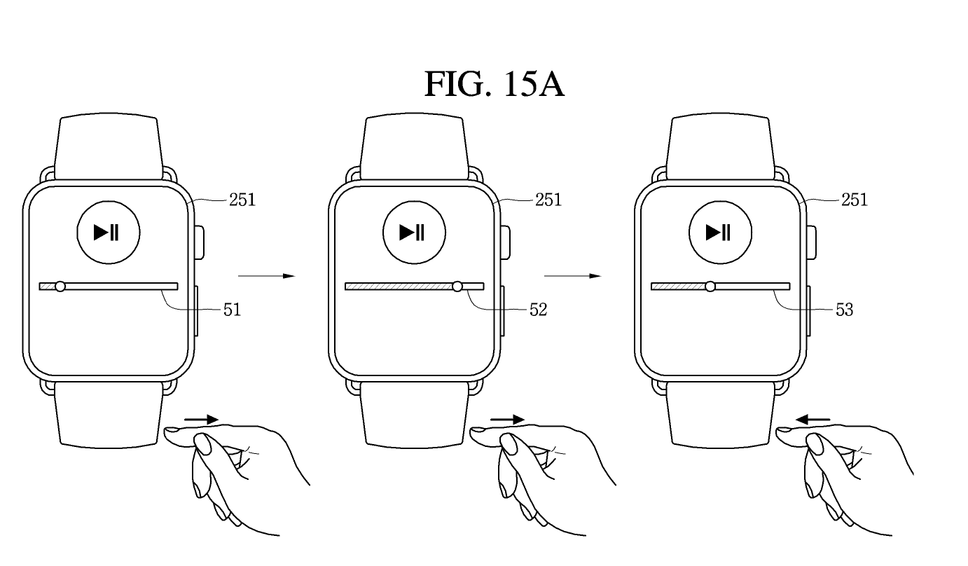

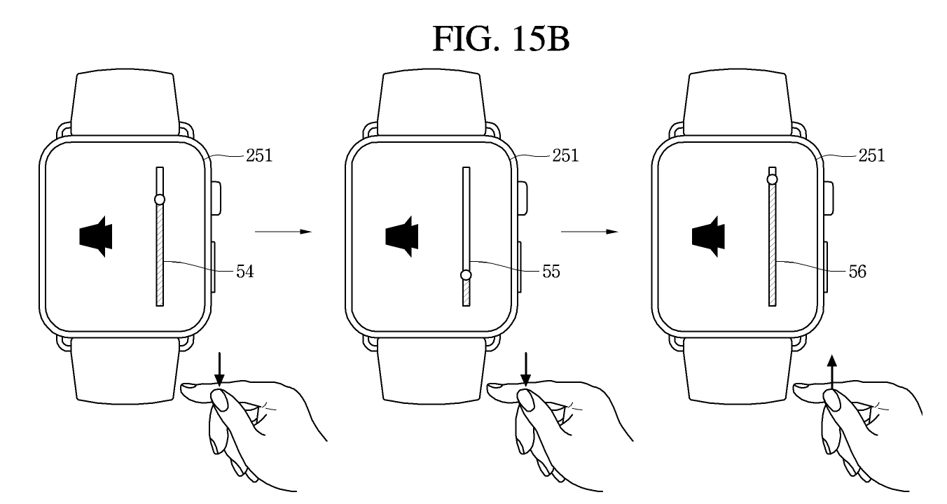

FIGS. 15a and 15b are diagrams illustrating a process of controlling a music application by a gesture according to an embodiment of the present invention.

In FIGS. 15a and 15b, assume that operation is performed in a gesture mode.

In the touch mode or the drag mode, due to restriction on screen size and touch operation, the status bar such as a progress bar or a volume bar is not displayed.

However, in the gesture mode, the user may adjust the progress bar or the volume bar and the slider displayed on the touchscreen 251 by finger motion outside the touch region, thereby easily performing fine control of a playback speed and volume.

Referring to FIG. 15a, the progress bars 51, 52 and 53 are displayed on the touchscreen 251. The progress bars 51, 52 and 53 indicate at which point of a total playback time playback is performed. In this case, the user may rub the index finger with the thumb in the left-and-right direction to move the progress bars 51, 52 and 53 back and forth.

When the user rubs the index finger with the thumb in the right direction outside the touchscreen 251 shown at the leftmost side of FIG. 15a, the progress bar 51 moves backward. Specifically, when the thumb is rubbed in the right direction, the progress bar 52 moves backward like the touchscreen shown at the middle side of the figure to move the playback time point of music backward and, when the thumb is rubbed in the left direction, the progress bar 53 moves forward like the touchscreen shown at the rightmost side of the figure to move the playback time point of music forward.

Referring to FIG. 15b, volume bars 54, 55 and 56 are displayed on the touchscreen 251. The volume bars 54, 55 and 56 indicate at which volume level of a total of volume levels playback is performed. In this case, the user may rub the index finger with the thumb in the up-and-down direction, thereby moving the volume bars 54, 55 and 45 up or down.

When the user rubs the index finger downward with the thumb outside the touchscreen 251 shown at the leftmost side of FIG. 15b, the volume bar 54 moves downward. Specifically, when the thumb is rubbed downward, the progress bar 55 moves downward to decrease the playback volume and, when the thumb is rubbed upward, the progress bar 55 moves upward to increase the playback volume.

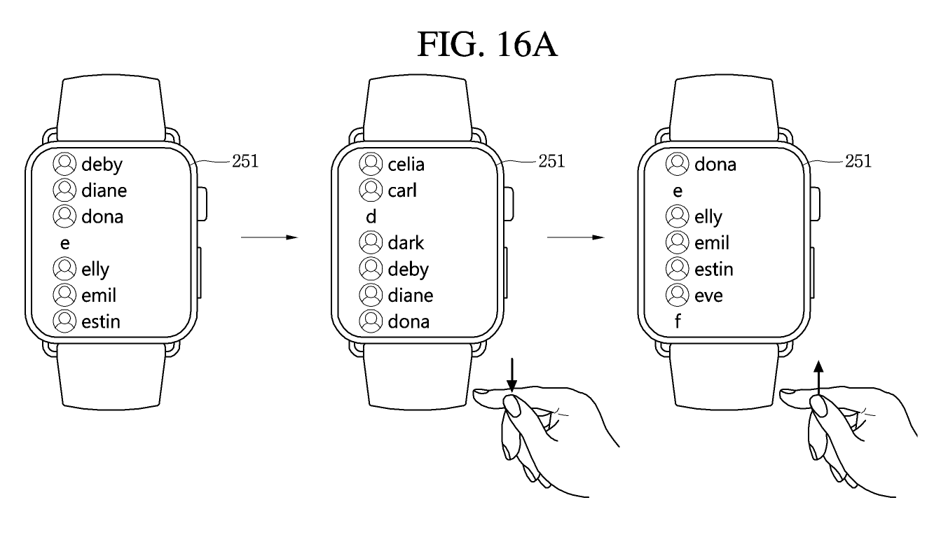

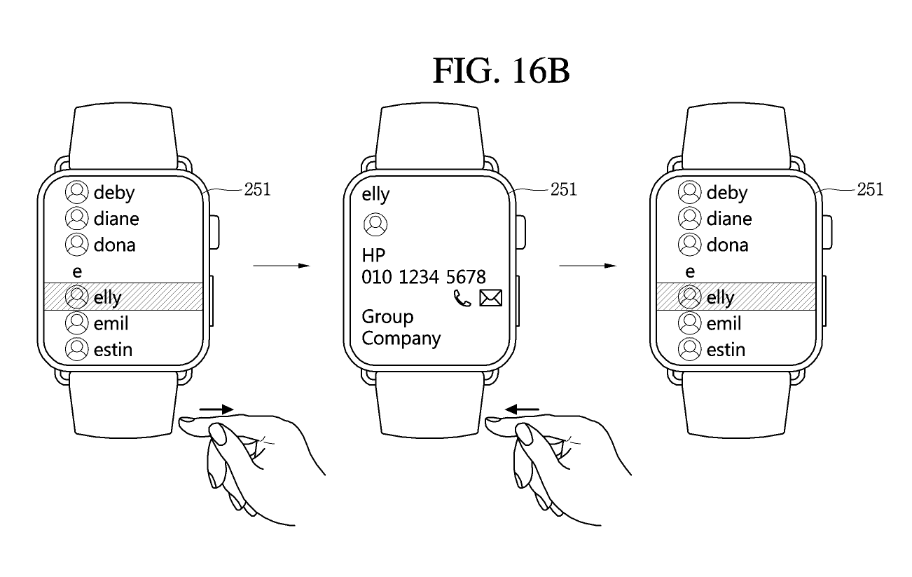

FIGS. 16a and 16b are diagrams illustrating a process of controlling an address book application by a gesture according to an embodiment of the present invention.

Referring to FIG. 16a, the user may rub the index finger up and down with the thumb to turn the pages of an address book. When the user repeats the above operation several times, the pages are continuously turned backward or forward to display a last page or a first page.

When the user rubs the index finger downward with the thumb once, the screen is scrolled down to display the items located at the upper end of the list like the screen shown at the middle side of the figure.

Here, when the user rubs the index finger upward with the thumb once, the screen is scrolled up to display the items located at the lower end of the list like the screen shown at the rightmost side of the figure.

Meanwhile, when the user makes a gesture of rubbing the index finger with the thumb in the right or left direction on the address book list shown in FIG. 16a, it is possible to zoom the address book list in or out. Specifically, when the address book list is zoomed in, detailed information of a selected item may be displayed and, when the selected list is zoomed out, the screen may return to the address book list.

Referring to FIG. 16b, when the user selects elly from the address book list and then rubs the index number to the right with the thumb, the selected address is zoomed in and detailed information thereof is displayed. When the user rubs the index finger to the left with the thumb in a state of displaying the detailed information, the detailed information is zoomed out to return to the page on which the address is displayed.

The present invention as described earlier may be implemented as a computer readable code in a medium having a program thereon. The computer readable medium includes all kinds of storage devices storing data that may be read by a computer system. Examples of a computer readable medium are a hard disk drive (HDD), a solid state disk (SSD), a silicon disk drive (SDD), a ROM, a RAM, a CD-ROM, a magnetic tape, a floppy disk, and an optical data storage device, and it is also implemented in the form of a carrier wave (e.g., data transmission through the Internet). Also, the computer may also include a control unit 180 of a terminal. Thus, the detailed description should not be construed as limitative in all aspects and should be considered exemplary. The scope of the prevent invention should be defined by the reasonable understanding of the following claims and all changes falling within the equivalent scope of the prevent invention are included in the scope of the prevent invention.

What is claimed is:

1. A watch type mobile terminal comprising:
a display unit including a touchscreen and a bezel surrounding a border of the touchscreen to receive first operation for dragging to the bezel on the touchscreen;
a sensing unit configured to recognize second operation for moving a finger of a user at a predetermined distance from the watch type mobile terminal; and
a control unit configured to switch to a gesture mode in which the watch type mobile terminal is controlled by the second operation when the first operation is received.

2. The watch type mobile terminal according to claim 1, wherein the second operation is operation for moving a thumb and an index finger of the user at the predetermined distance from the watch type mobile terminal without touching the touchscreen.

3. The watch type mobile terminal according to claim 1, wherein the first operation is operation for performing dragging to deviate from the touchscreen by a predetermined distance within a predetermined time.

4. The watch type mobile terminal according to claim 1, wherein the control unit maintains the gesture mode until touch operation is input to the touchscreen, upon switching to the gesture mode.

5. The watch type mobile terminal according to claim 1, wherein the control unit increases the number of items of a content list displayed on the touchscreen upon switching to the gesture mode.

6. The watch type mobile terminal according to claim 1, wherein the control unit displays at least one of a progress bar for controlling a playback time point and a volume bar for controlling a playback volume level when any one of a moving image or music application is executed upon switching to the gesture mode.

7. The watch type mobile terminal according to claim 1, wherein the sensing unit transmits a radio frequency (RF) signal, analyzes a pattern of the RF signal reflected from the finger, and recognizes the second operation.

8. The watch type mobile terminal according to claim 1, wherein the control unit performs control operation for controlling the watch type mobile terminal in correspondence with the second operation.

9. The watch type mobile terminal according to claim 8,
wherein the second operation comprises at least one of operation for rubbing an index finger with a thumb in a left-and-right direction, operation for rubbing the index finger with the thumb in an up-and-down direction, operation for rubbing the index finger with the thumb while rotating in a horizontal plane and operation for rubbing the index finger with the thumb while rotating in a vertical direction, and
wherein the control unit performs the control operation of at least one playback time point control, playback volume level control, zoom-in/out and page turning in correspondence with the second operation.

10. A method of operating a watch type mobile terminal, the method comprising:
receiving first operation for dragging to a bezel on a touchscreen; and
switching to a gesture mode in which the watch type mobile terminal is controlled by second operation for moving a finger of a user at a predetermined distance from the watch type mobile terminal, when the first operation is recognized.

11. The method according to claim 10, wherein the second operation is operation for moving a thumb and an index finger of the user at the predetermined distance from the watch type mobile terminal without touching the touchscreen.

12. The method according to claim 10, wherein the first operation is operation for performing dragging to deviate from the touchscreen by a predetermined distance within a predetermined time.

13. The method according to claim 10, wherein the gesture mode is maintained until touch operation is input to the touchscreen, upon switching to the gesture mode.

14. The method according to claim 10, wherein the number of items of a content list displayed on the touchscreen is increased upon switching to the gesture mode.

15. The method according to claim 10, wherein at least one of a progress bar for controlling a playback time point and a volume bar for controlling a playback volume level is displayed when any one of a moving image or music application is executed upon switching to the gesture mode.

16. The method according to claim 10, wherein a radio frequency (RF) signal is transmitted, a pattern of the RF signal reflected from the finger is analyzed, and the second operation is recognized.

17. The method according to claim 10, wherein control operation for controlling the watch type mobile terminal is performed in correspondence with the second operation.

18. The method according to claim 17,
wherein the second operation comprises at least one of operation for rubbing an index finger with a thumb in a left-and-right direction, operation for rubbing the index finger with the thumb in an up-and-down direction, operation for rubbing the index finger with the thumb while rotating in a horizontal plane and operation for rubbing the index finger with the thumb while rotating in a vertical direction, and
wherein the control unit performs the control operation of at least one playback time point control, playback volume level control, zoom-in/out and page turning in correspondence with the second operation.
